(19) United States
(12) Patent Application Publication
(10) Pub. No.: US 2025/0242997 A1
(43) Pub. Date: Jul. 31, 2025

(54) COMPOSTABLE POD FOR BEVERAGE PREPARATION

(71) Applicant: SOCIETE DES PRODUITS NESTLE S.A., Vevey (CH)

(72) Inventors: CAMILLE MARIE-ROSE ELIANE DAGANAUD, Pully (CH); CHRISTOPHE SEBASTIEN PAUL HEYDEL, Chez Le Bart (CH); FREDERIC DOLEAC, Vaux et Chantegrue (FR)

(21) Appl. No.: 18/854,212

(22) PCT Filed: Apr. 5, 2023
(86) PCT No.: PCT/EP2023/058915

§ 371 Date: Oct. 4, 2024

(30) Foreign Application Priority Data
Apr. 5, 2022 (EP) 22166847.8

(51) Int. Cl. B65D 85/804

(52) U.S. Cl. CPC B65D 85/8046; B65D 85/8061

(57) ABSTRACT

The invention relates to a pod (100, 200) for preparing a beverage in a beverage production machine, wherein the pod (100, 200) is made of a biodegradable, preferably compostable, material composition and comprises a pod body (110) composed of two half-shells (101, 102) being connected to each other along their respective circumferential flange (140) so as to delimit a chamber (103) for containing a substance (105) for the preparation of the beverage. The at least one half-shell comprises in a layered manner: • A primary layer (171) made of a paper-based material; • A secondary layer (172) with at least an oxygen barrier function and optionally a water barrier function; and • An at least partial, tertiary layer (173) with a filter function, The primary layer of said at least one half-shell (106) comprises at least one non-traversing pre-cut hole and/or scratch forming a pre-cut pattern (108) or scratch's pattern (I, CE) over at least a delivery portion (130) of the half-shell adapted to interact with external opening elements of the beverage production machine, under the effect of rising pressure of the fluid being injected into the pod (100, 200) through an injection portion (120) on the other half-shell (101, 102), to dispense the prepared beverage from the pod (100, 200). The invention also relates to the use of said pod in a beverage production machine.

### 1. FIELD OF THE INVENTION

The present invention relates to a pod enclosing a beverage ingredient for preparing a beverage in a beverage production machine, the pod having a wall portion that opens upon interaction with opening elements of the beverage production machine under the effect of rising pressure of a fluid being injected into the pod for preparing the beverage.

### 2. TECHNICAL BACKGROUND

Single-serve beverage containers for beverage preparation machines, such as capsules or pods, are known in the art. These beverage containers are commonly used for on demand dispensing of beverages, like coffee, tea or hot chocolate, and enjoy popularity due to fresh tasting, variability of flavours and convenience of the beverage preparation.

Usually, the beverage container containing a beverage component is inserted in a container holder of a beverage preparation machine, the container holder is closed, and preparation of the beverage is started. Fluid, such as hot water or milk, is delivered to the beverage container to interact with the beverage component contained inside the beverage container to produce the desired beverage. When a sufficient amount of the fluid fills the beverage container, the beverage container opens under pressure of the fluid to release the prepared beverage. Opening of the beverage container can be accomplished by pressing an extraction face of the beverage container with a force effected by increasing the pressure of the fluid inside the beverage container against an opening structure provided in the container holder such that the extraction face is torn upon reaching a breaking stress. The opening structure can be a number of relief and recessed elements, e.g. pyramid-like elements, onto which the extraction face extends and tears under the effect of the internal pressure of the fluid. Such pressure-controlled beverage preparation has the advantage that it can produce a beverage of high quality.

Typically, known beverage containers are made of materials, for which reusing, recycling or composting requires a challenging process, in particular after the use of the beverage container. For example, the beverage containers can often comprise non-biodegradable plastic, e.g. polypropylene, and/or metal, e.g. Aluminium.

Therefore, in the prior art, different attempts were undertaken to replace these materials with biodegradable or compostable materials, such as biodegradable polymers or paper. This poses numerous challenges since food-packaging applications generally place high requirements on the barrier performance of the packaging in order to keep the packaged product's aromas, freshness and integrity intact over the entire intended shelf life. Moreover, it is necessary that the new materials match most of the material characteristics of the established materials, such as their resistance to heat and pressure.

In experiments not disclosed to the public, promising results were obtained for a compostable beverage container, which comprises a cut-out that is covered by a material forming the extraction face. The material of the extraction face is different from the rest of the beverage container and is adapted to be opened during the beverage preparation process. For example, patent application PCT/EP21/077158 describes such beverage containers.

A pod as disclosed in document WO2020/031096 A1 has also been successfully tested. The proposed compostable pod for brewing products comprises a first and a second half-shell, each made of a sheet of biodegradable material with gas barrier properties that are assembled together. The shaping of the half-shells comprises a step of moistening the sheets of biodegradable material.

These solutions, even if already considered as satisfactory vis-à-vis many aspects including, a good behaviour in the extraction process and a high-quality of the extracted product, may be further improved, especially on simplifying the industrialisation production process and/or on providing a beverage container with a fully reliable oxygen barrier to ensure the duration of the beverage product's shelf life.

Complementary, the proposed solution should also ensure that the beverage ingredient particles do not end in the prepared beverage or that the particles of the beverage ingredient do not clog the perforations done in the pod wall portion during interaction with the opening elements of the beverage production machine.

Moreover, in order to meet biodegradable, preferably compostable conditions, the materials selection has to comply with standards relating to biodegradability and/or compostability.

Accordingly, it is an object of the invention to provide a beverage container, such as a pod, with a design and configuration, which meets the above-described requirements.

In particular, it is an object of the invention to provide a beverage container having a simple construction and making use of a biodegradable, preferably compostable base material that can be easily formed without any humidifying step while allowing a good behaviour in the extraction process, especially in relation to the opening of the beverage container on the opening/piercing structure of the beverage preparation machine.

Additionally, it is an object of the invention to provide a beverage container that facilitates home-composting of the entire beverage container after its use and that can be provided with a reliable and effective oxygen barrier while maintaining the functionality of known beverage containers so that the improved beverage container can be used also with known and conventional beverage production machines.

These and other objects, which become apparent upon reading the description, are solved by the subject-matter of the independent claims. The dependent claims refer to preferred embodiments of the invention.

### 3. SUMMARY OF THE INVENTION

A first aspect of the invention relates to a pod for preparing a beverage in a beverage production machine according to claim 1.

In more details, the pod is made of a biodegradable, preferably compostable, material composition and comprises a pod body composed of two half-shells being connected to each other along their respective circumferential flange so as to delimit a chamber for containing a substance for the preparation of the beverage. In the proposed pod, at least one half-shell comprises in a layered manner:
A primary layer made of a paper-based material
A secondary layer with at least an oxygen barrier function and optionally a water barrier function; and
An at least partial, tertiary layer with a filter function,
   wherein the primary layer of said at least one half-shell comprises at least one non-traversing (non-crossing), pre-cut hole and/or cut and/or scoring and/or scratch, forming a pre-cut hole's pattern and/or a scratch's or scoring's pattern over at least a delivery portion of the half-shell adapted to interact with external opening elements of the beverage production machine, under the effect of rising pressure of the fluid being injected into the pod through an injection portion on the other half-shell, to dispense the prepared beverage from the pod.

The at least one non-traversing pre-cut hole and/or scratch forms a fracture or opening initiation that can also be described as a starting point of opening during the pod extraction in the beverage production machine.

Therein, a pod may be understood, for example, as a receptacle or container enclosing a volume for containing a substance required for beverage preparation. The pod may be flat and (generally) rounded in shape, and/or may have the shape of a (circular and/or double-convex) lens. The pod may be formed by two (with respect to the volume) outwardly curved (bulging) surfaces that may extend in opposite directions from a common parting plane. Thus, unlike a capsule for beverage preparation, such as the ones known in the art, a pod may, for example, not comprise a substantially flat top surface (which in said capsules is typically formed by a lid).

Just for completeness, it is noted, at least for the protection requested in the main claims, that it is not intended to express a certain order or importance of the layers by referring to them as “primary”, “secondary” and tertiary layers.

The pod is in its entirety biodegradable. However, it is preferably compostable and most preferably home compostable. It is made of a combination of biodegradable material, of a combination of compostable material, of a combination of home-compostable material or of a combination of biodegradable, compostable and home-compostable material.

Generally, the term “biodegradable” may be understood as meaning that a material is capable of being decomposed by bacteria or other biological means.

Generally, the term “compostable” may be understood as meaning that a material may be substantially broken down into organic matter within a few weeks or months when it is composted. At the end of a composting process, the earth may be supplied with nutrients once the material has completely broken down. International standards, such as EU 13432 or US ASTM D6400, provide a legal framework for specifying technical requirements and procedures for determining compostability of a material. For instance, according to these standards, compostable materials must be biodegradable and disintegrable, i.e. fragmentation and invisibility in the final compost, and must not have negative effects on the composting process and quality. Composting may be accomplished in home composters and/or industrial composting sites. Defined conditions relating to wind, sunlight, drainage and other factors may exist at such sites. Home-compostable materials may be composted in home composters, such as compost barrels or a home compost bin over a period of weeks or months (e.g. at least 90% degradation of materials in 12 months at ambient temperature). As a result of the composting process, the home-compostable materials may be converted into a nutrient-rich soil. Thus, a home-compostable pod can be simply disposed in a home-compost pile after its use. Further, the term “material composition” may be understood, for example, as the constitution, combination and/or arrangement of (different) materials, which preferably form (altogether) a (uniform) structure, such as the pod or a section thereof.

The pod comprises a pod body, which is composed of two half-shells. The two half-shells are connected to each other so as to delimit a chamber for containing a substance for the preparation of the beverage.

Therein, a “chamber” may be understood, for example, as a (sealingly) enclosed hollow space inside the pod body. The pod may be composed of two pod halves, such as the two half-shells, which may be coupled (/joined/attached/adhered/sealed) to each other in order to form together the pod body. In comparison, a capsule for beverage preparation as known in the prior art may comprise a capsule body composed by a continuous wall and may comprise at the top (and/or the bottom) of the capsule an opening that is (are) closed by a (substantially flat) membrane, e.g. a lid (, respectively). Hence, the shape of a capsule may be (primarily) defined by its capsule body while the shape of a pod may be defined by the two half-shells when connected. Further, “substance” may be understood, for example, as any type of (solid, liquid, at least partially soluble and/or percolate-able) matter of a particular or definite chemical constitution. Examples for substances may be instant or roasted ground coffee, tealeaves, syrup or fruit extract concentrate, chocolate, dehydrated edible substances, and/or combinations thereof.

Therein, the expression “oxygen barrier function” may be understood, for example, as a feature, property, characteristic or behaviour (of the material) in relation to blocking oxygen (or any other gaseous substance) from passing through a material comprising the oxygen barrier function.

The pod may further comprise an injection portion through which a fluid is injected in the chamber for preparing the beverage upon interaction of the fluid with the substance.

The pod may also comprise a delivery portion adapted (configured) to be opened upon (direct) interaction with external opening elements (of the beverage production machine) under the effect of rising pressure of the fluid being injected (through the injection wall) into the pod to dispense the prepared beverage from the pod.

Therein, the expression “adapted to be opened” may be understood, for example, as capability, configuration and/or design of the delivery wall to be provided with holes, punctures and/or ruptures, preferably during the beverage preparation process. For instance, the provision of such openings preferably may be subject to certain conditions and/or circumstances, such as the provision of the opening elements and/or excess of a certain pressure inside the pod. This illustrates that a pod, unlike commonly known pads for beverage preparation, facilitates the build-up of pressure inside the chamber that is sufficient to open the pod at the location of the delivery portion in the above-specified manner with external opening elements.

According to one aspect of the invention, the primary layer is made of stretchable and/or formable paper-based material having an elongation at break of at least 6%. Thanks to the paper that is used, the half-shells can be easily formed and shaped in a forming process that does not require any additional humidifying or preparation step.

Therein, the term “formable” may be understood, for example, as the characteristic of a material being malleable, pliable, and/or shapable, preferably with/without the support of additional tools and/or preferably with/without the application of heat and/or water, and/or compressed air.

For example, in a dry pulp moulding process, a blank of dried cellulose fibers may be provided and formed with a tool into a (permanent) shape of the pod. For instance, the formable material of the pod may facilitate to provide the pod with form-stability, stiffness and/or rigidity, each of which preferably being sufficient for building up pressure inside the pod during beverage preparation.

Specifically, the primary layer is arranged opposite to the chamber with respect to the secondary layer and therefore constitutes the external (or outer) surface of the pod.

In a complementary way, the tertiary layer is arranged facing the chamber with respect to the secondary layer and therefore constitutes the interior of the chamber.

In the proposed solution, the primary layer is made of a biodegradable, preferably compostable paper-based material selected from the group comprising paper, supercalendered paper, filter paper and combination thereof and has a grammage comprised between 50 and 150 g/m2.

In more details, the primary layer comprises between 1 and 150 pre-cut holes forming thereby a pre-cut hole's pattern.

The scratches, cuts or scorings may be local of may form a geometric shape or may be of any shape or may form of logo.

The pre-cut holes or scratches may be made using different technologies. For example mechanical puncturing, laser engraving or laser scoring.

The pre-cut holes or scratches may have different geometry and could for example be in the form of a circle, a slit, a cross or any other suitable shape. The pre-cut holes or scratches may then form pre-cut hole's patterns, scratch's patterns or localized cuts or scorings.

Different pre-cut hole's patterns, scratch's patterns or scoring's patterns may be used according to the size of the pod and/or according to the characteristics of the primary layer and/or of the opening means of the beverage production machine. The pre-cut hole's scratches or scoring's patterns may also depend on the beverage ingredient to be extracted.

It is to be noted that the pre-cut holes, scratches, cuts or scorings only extend in the primary layer and do not extend in the secondary layer so that the oxygen barrier function and the resulting pod properties against ingredient oxidation are fully kept.

Preferably, the pre-cut holes, scratches, cuts or scorings extend over the primary layer thickness, preferably over 50% of the primary layer thickness without extending to the secondary layer.

According to a further feature, the primary layer comprises scratches, cuts or scorings in the form of information (1) and/or coded elements (CE) stamped on the external surface of said primary layer at the location of the delivery portion and/or at the location of the injection portion, providing localized weakness of the primary layer. The provided localized weakness improves the ability of the delivery portion and/or injection portion to be pierced by the external opening elements of the beverage production machine.

According to the invention, the secondary layer is biodegradable, preferably compostable, and comprises a coating or a preferably multilayer compostable plastic film structure.

Therein, the expression “multilayer structure” may be understood, for example, as a structure comprising different parts that are arranged in pleats, slats, tiers or as strata. Preferably, the layers may be arranged such that they may extend parallel to each other to form a film. Preferably the different layers are laminated so as to form a foil or a film. However, other technologies “linking” the different layers are available as for example blown and/or cast film coextrusion, extrusion coating or even sealing.

Thereby, it is possible to provide the secondary layer from compostable, preferably home-compostable, materials having particularly good oxygen barrier properties. Moreover, the provision of coatings facilitates that the secondary layer may be provided as a continuous and relatively thin layer (e.g. below 0.1 microns).

According to a preferred embodiment, at least some of the layers of the multilayer structure of the secondary layer may be connected by lamination, coextrusion, heat sealing, by ultrasonic sealing, and/or by an adhesive.

Preferably, the coating or the preferably multilayer compostable plastic film structure comprises one or more of:
a Polylactic acid (PLA) layer,
a Polybutylene succinate (PBS) layer,
a Polybutylene adipate terephthalate (PBAT) layer,
a Polyhydroxy alkanoate (PHA) layer,
a Polycaprolactone (PCL) layer,
any combination thereof.

More particularly, at least one layer of the preferably multilayer compostable plastic film structure is enriched with Calcium Carbonate (CaCO3) in a range between 1 and 70 weight %. The use of CaCO3 is of particular interest as may reduce the quantity of expenses material, for example Ecovio® that is needed. Additionally, it does not change the barriers properties and the home-compostability.

In addition, the secondary layer comprises an oxygen barrier layer comprising one or more of:
a Butenediol-vinyl-alcohol-copolymer (BVOH) layer,
a Polyvinyl-alcohol (PVOH) layer,
a PVOH copolymer layer,
a Polyglycolic acid (PGA) layer, or
a metallization coating,
a SiOx based coating,
an AlOx based coating or
a combination thereof.

Specific combinations of material forming oxygen barrier layer that are commercially available, for example under the name Ecovio© may be used.

Additional layers comprising additional physical properties may be provided. For example, layers have moisture or water barrier function may be provided. Such layer may for example comprise cellophane, a metallization coating, a SiOx coating, or an AlOx based coating.

As a consequence, the secondary layer comprises a structure preferably a multilayer structure, wherein each of the layers can be tailored to provide an individual function to the secondary layer. For example, the described multilayer structure of the secondary layer of the pod of the invention facilitates that multiple (different) materials can be used, each capable of performing at least one function.

Thereby, it is possible to provide a biodegradable, preferably compostable, most preferably home-compostable, pod having an efficient oxygen barrier and optionally a water/moisture barrier. Thus, with the configuration of the invention, a pod with the above-described desired properties can be provided.

Therein, preferably the coating or the multilayer compostable plastic film structure may be applied (directly) onto the primary layer. The primary layer and the secondary layer may be laminated to form a duplex film. Other technologies like for example extrusion coating may be used.

Thanks to the proposed configuration, the oxygen barrier properties of the pod can be improved since it is possible to provide the oxygen barrier as a single layer extending continuously with the pod body and the delivery wall.

Thereby, individual layers of the multilayer compostable plastic film structure can also be arranged in a manner most suitable for providing the functionality needed for preparing the beverage.

Furthermore, the invention proposes to use a tertiary layer having a filter function. The tertiary layer may then filter out particles that otherwise may leave the chamber during the preparation process.

Thereby, it can be achieved that the tertiary layer can act as a filter for filtering out particles from the prepared beverage when the prepared beverage is dispensed at the location of the delivery portion.

Hence, the pod can be filled with various substances without risking the quality of the produced beverage.

The tertiary layer is biodegradable, preferably compostable and comprises one or more of a filter material comprising one or more of the following materials:
Polylactic acid (PLA),
Polybutylene succinate (PBS),
Bio Polybutylene succinate (Bio PBS),
Ecovio®,
Cellulose fibers-based material,
Regenerated cellulose (cellophane), or
a combination thereof.

According to a preferred embodiment, the tertiary layer may comprise a cellulose fibers-based material that may contain one or more of a paper, a supercalendered paper and/or a filter paper.

Additionally, and according to the technically viable solution, the tertiary layer, in accordance with the material it is made of, has a structure comprised within the group comprising a non-woven structure, a calendared structure and a pierced structure.

In a proposed embodiment, the tertiary layer extends at least over the delivery portion of a half-shell. This feature allows reducing the quantity of material in the pod if necessary.

The tertiary layer may be positioned on the secondary layer loosely or may be at least partially linked to the secondary layer, thereby allowing different possible embodiment, for example depending on the size of the pod or on the beverage substance to be extracted.

The tertiary layer may be linked to the secondary layer by any suitable means, for example it can be sealed, glued, laminated embossed, lasered connected, etc.

In particular, the tertiary layer is part of a laminated triplex structure comprising at least the primary layer, the secondary layer and the tertiary layer.

According to an additional feature, when needed, the secondary layer or the tertiary layer further comprises a sealing layer or a sealing lacquer, at least at the location of the half-shell's flange, for allowing the sealing of the two half-shells together. The proposed sealing layer/lacquer ensure proper sealing of the two half-shells as well as an improved tightness of the resulting pod.

According to the presented embodiments, the half-shells are each formed by shaping an initial sheet element.

In a first proposed embodiment, two initial sheet elements are used for forming the two half-shells. These two sheet elements may have the same structure and may each comprise the above described primary, secondary and tertiary layers.

The initial sheet elements may be each shaped into a half-shell, by drawing at least part of the respective initial sheet element into a forming die, preferably by mechanical action of a punch or compressed air, more preferred by deep drawing the respective sheet element. Additional cutting may be applied to provide separate individual half-shells.

According to a preferred feature, at least one or both half-shells may have a disc shape. However, other shapes and other geometries may be envisaged

According to a further preferred feature, each of the two half-shells may comprise a circumferential flange, wherein the two half-shells may be connected to each other via their circumferential flanges after one of the half-shells have been filled in with a beverage ingredient.

According to a preferred embodiment, the two half-shells may be connected under the application of vacuum and under the application of heat sealing or ultrasonic sealing, wherein preferably the half-shells may be sealingly connected via a sealing section extending along the perimeter of each of the half-shells, preferably along the circumferential flanges, if present.

In addition, it may be possible to compact the beverage ingredient before or once the beverage ingredient is inside the half-shell before connecting assembling the two half-shells forming the pod body.

In a proposed embodiment, the pre-cut holes/scratches/cuts/scorings are made on the paper-based material prior to linking, for example by lamination, the secondary layer (having the barrier function) to the primary layer. This is particularly interesting as it allows to have the pre-cut holes or scratches limited to the paper-based layer without any possible interaction with the barrier layer (secondary layer having the barrier function). Hence there is no possible damage of the barrier layer as the pre-cut holes or scratches are done in an up-stream process.

Going in the details of the pre-cut holes, the pre-cut hole(s) may preferably be done on the initial sheet element before the half-shell is shaped but it may also be done once the pod is assembled.

Preferably, the primary, secondary and tertiary layers are in the form of a laminated triplex (as previously described) and the tertiary layer extends on the entire surface of the initial sheet element.

However, other configurations may be envisaged. For example in the laminated triplex, the tertiary layer may extend only over a portion corresponding to the injection and/or delivery portion.

Alternatively, the tertiary layer may be linked by any suitable means to a laminated duplex comprising the primary and the secondary layer and may as well extend over the entire surface of the initial sheet element only over a portion corresponding to the injection and/or delivery portion. The tertiary layer may have a specific shape or extending all over the laminated duplex film.

In another alternative way, the tertiary layer may be applied loosely on the laminated duplex comprising the primary and the secondary layer inside the half-shell comprising the delivery wall. The complementary half-shell having one of the above-described configurations.

It is to be noted that if the tertiary layer only extends over a portion corresponding to the injection and/or delivery portion of the half-shell, an additional sealing layer may be applied on one or both of the half-shells to provide efficient sealing when the two half-shells will be connected.

According to the proposed embodiments, the half-shells may each be made of the same material or the same material composition and may each present the same arrangement and configuration.

Preferably, the pre-cut hole(s) may be done on one or both half-shells forming the pod without impacting the functionality and the tightness of the pod.

In addition, the pod body (formed by assembling the two half-shells) can be provided in numerous shapes and forms as the formable material allows for being relatively free in designing the pod body. The possible pod design may depend on the beverage production machine.

Thereby, it is possible to manufacture and propose a home-compostable pod with an oxygen barrier, keeping the sensory properties of the beverage ingredient stored therein.

According to the proposed invention, it is possible to provide a pod with a symmetric configuration so that the manufacturing process can be simplified. By providing a pod with a symmetric layout: similar half-shells shapes and dimensions having each the same pre-cut hole's pattern, the proposed pod design and structure can be simplified and optimized.

Moreover, this is particularly advantageous as the user does not have to pay attention on how to place the pod in the beverage production machine. With such pod configuration, the flow path for the fluid can be defined through the pod so that the beverage preparation process can be improved.

A further aspect of the invention relates to the use of anyone of the proposed pods (including the pod produced in the manufacturing method) for preparing a beverage in a beverage production machine that has a pod holder with opening elements (i.e. external to the pod).

Thereby, a beverage can be produced with a pod that consists of home-compostable materials while retaining all functionalities known from pods established in the prior art. Further, the pod can be used with already existing beverage production machines.

Thus, it is possible to produce a beverage of high quality with a pod that overcomes the problems presently existing with the disposal of prior art pods.

The following description of preferred embodiments of the invention are equally applicable to the pods according to the different aspects of the invention.

### 4. BRIEF DESCRIPTION OF DRAWINGS

Further features, advantages and objects of the invention will become apparent for the skilled person when reading the following detailed description of embodiments of the invention and when taking in conjunction with the figures of the enclosed drawings. In case numerals have been omitted from a figure, for example for reasons of clarity, the corresponding features may still be present in the figure.

FIG. 1 shows a schematic cross-section of an embodiment of a pod according to the invention.

FIG. 2 shows a perspective view of a further embodiment of the pod according to the invention.

FIG. 3 shows a top view of a pod on the side of the delivery portion and comprising pre-cut holes. Each an enlarged sectional view of a portion of a delivery wall from different embodiments of the pod according to the invention.

FIG. 4 shows an enlarged sectional view of a portion of a delivery wall from an alternative pod according to the invention.

FIGS. 5a to 5d show different embodiments of the pre-cut hole pattern according to the invention.

### 5. DETAILED DESCRIPTION

As used in this specification, the words “comprises”, “comprising”, and similar words, are not to be interpreted in an exclusive or exhaustive sense. In other words, they are intended to mean including, but not limited to. Any reference to prior art documents in this specification is not to be considered as an admission that such prior art is widely known or forms part of the common general knowledge in the field.

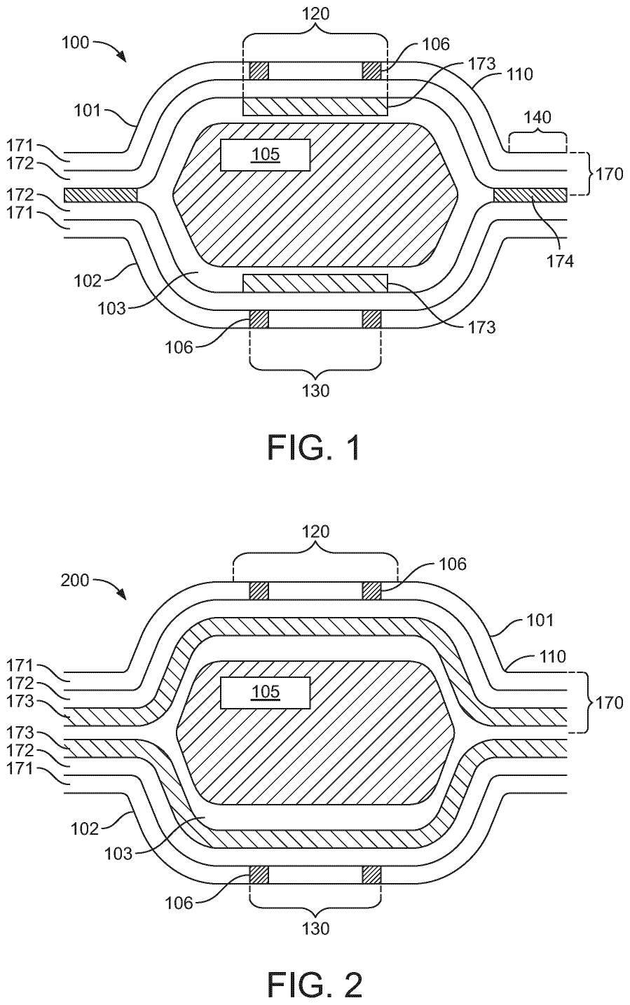

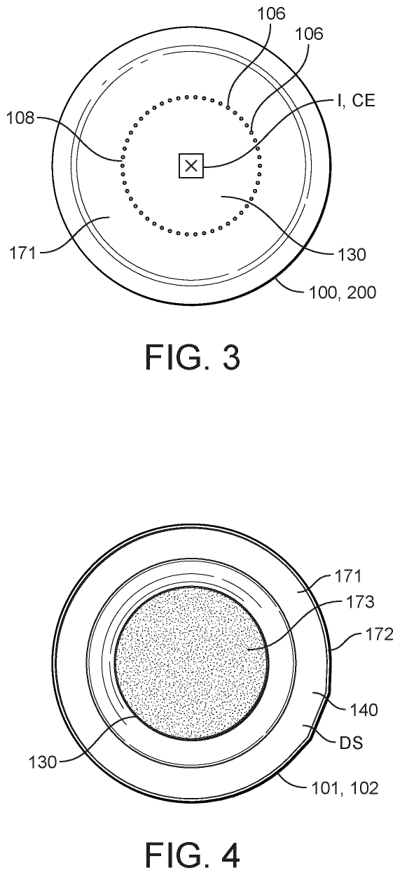

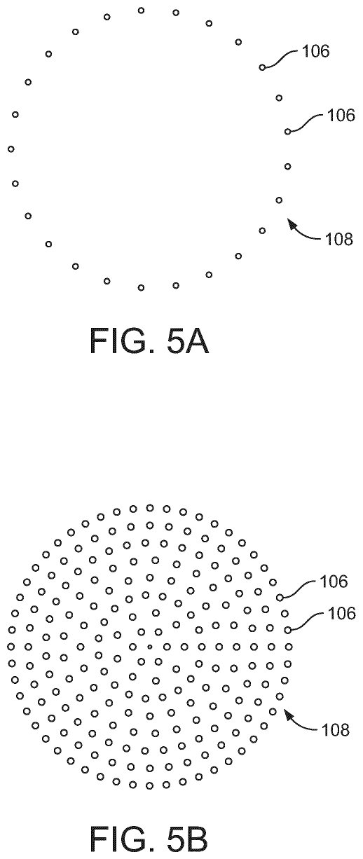

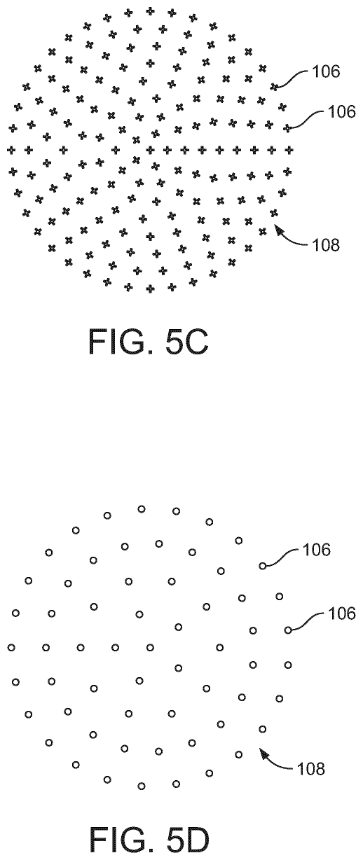

FIGS. 1 and 2 show cross sections of two proposed embodiments of pods 100, 200 according to different aspects of the present invention. FIGS. 3 and 4 respectively show an external view and an internal view of the pods 100, 200 while FIG. 5a to 5d present different pre-cut hole's patterns.

The invention relates in general to a pod 100, 200 (suitable/configured) for preparing a beverage in a beverage production machine. The beverage production machine may comprise elements for injecting fluid into the pod 100, 200 and elements for opening the pod 100, 200 under the effect of rising pressure of a fluid that is injected into the pod 100, 200. FIGS. 1 and 2 show examples of the pods 100, 200.

The pod 100, 200 is made of a biodegradable and more preferably made of a compostable material composition. Thus, for example, the pod 100, 200 may be made entirely from compostable materials so that the pod 100, 200 may be simply disposed in industrial and in home compost piles after its use. Thus, the entire contents of the pod 100, 200 including any beverage components contained therein, may be compostable and preferably home compostable.

However, even if some of the pod materials are only qualified as biodegradable, their combination with other compostable/home compostable material may allow the entire pod to keep the pod qualified as compostable/home compostable.

The pod 100, 200 comprises a pod body 110. The pod body 110 is exemplarily illustrated in FIGS. 1 and 2. For example, the pod body 110 may provide the stiffness and rigidity required for building up enough pressure inside the pod 100, 200 during beverage preparation. As exemplarily illustrated in FIGS. 1 and 2, the pod body 110 may delimit (or define) the general boundaries (and/or shape) of the pod 100, 200. Preferably, the pod body 110 may have a shape that corresponds to the shape of the pod holder of the beverage production machine.

The pod body 110 is composed of two half-shells 101, 102 as exemplarily illustrated in FIGS. 1 and 2. The half-shells 101, 102 may each mainly be made of the same material or of the same material composition or of the same material structure.

The two half-shells 101, 102 are connected to each other so as to delimit a chamber 103. For example, the two half-shells 101, 102 may be (sealingly) connected to each other via their circumferential flanges 140 under vacuum and by heat or ultrasonic sealing.

The chamber 103 is suitable for containing a substance 105 for the preparation of the beverage. For example, the substance 105 may be provided as a tablet made of compressed or compacted beverage powder, such as coffee powder. In general, the substance 105 may be any (extractable) food substance, such as ground coffee powder, tea or chocolate.

Further, the half-shells 101, 102 may have any shape, geometry or dimension. Preferably, the shape of the half-shells 101, 102 may correspond with the geometry of the pod holder. Examples for the geometry and design of the half-shells 101, 102 can be taken from FIGS. 1 and 2 illustrating that each of the two half-shells 101, 102 may comprise a circumferential flange 140, which may extend radially outward with respect to the respective half-shell 101, 102. Further, each of the half-shells 101, 102 may extend axially from a radially inner edge of the circumferential flange 140. The half-shells 101, 102 may be identical or different to each other. For example, the half-shells 101, 102 may differ in height.

In the proposed embodiments the pod is circular and has a total diameter including the flange portion 140 of approximately 53 mm. However the dimensions of the pod may vary, and the diameter may be comprised between 40 and 65 mm depending on the beverage preparation machine it is intended to be used in.

The pod 100, 200 further comprises an injection portion 120 at the location where a fluid (coming from the beverage production machine) will be injected a fluid in the chamber 103 for preparing the beverage through interaction of the fluid with the substance 105. For example, the injection portion 120 may interact or engage with injection elements of the beverage production machine during the beverage preparation process, through which a (hot, e.g. 60 to 120 degrees Celsius) fluid (under pressure, e.g. 1 to 20 bar) may be injected into the pod 100, 200. Therein, injection portion 120 is integrally part of the pod body 110. Preferably it is located on one side of the pod body 110.

The pod 100, 200 further comprises a delivery portion 130. The delivery portion 130 may be provided so that the beverage can be dispensed from the pod 100, 200 through the delivery portion 130 of the pod body 110 during the process of preparing the beverage. The delivery portion 130 is exemplarily shown in FIGS. 1 and 2.

The injection portion 120 and the delivery portion 130 may be made of the same or different material. The injection portion 120 and the delivery portion 130 may have the same or different dimensions. Preferably, the injection portion 120 and the delivery portion 130 may be arranged concentrically to each other and/or to the circumferential flanges 140. FIGS. 1 and 2 show this exemplarily. For example, in case the injection portion 120 and the delivery portion 130 may be made of the same material and may have the same dimensions.

The delivery portion 130 is adapted to be opened upon interaction with opening elements of the beverage production machine (i.e. opening elements may be external to the pod 100, 200) under the effect of rising pressure of the fluid being injected into the pod 100, 200 to dispense the prepared beverage from the pod 100, 200. For instance, the (external) opening elements may be provided by a pyramid plate in the pod holder of the beverage production machine.

In the proposed embodiments, the half-shells 101, 102 each may have a multi-layered body structure 170. This is exemplarily shown in FIGS. 1 and 2. Therein, the multi-layered body structure 170 may comprise a primary layer 171 that may be made of a cellulose-based material.

For example, primary layer 171 comprises a cellulose-based material, preferably a paper-based material. The paper-based material may be stretchable or formable paper material and/or parchment paper having an elongation at break of at least 6%. For example, the material of the half-shells 101, 102 may be formable by being stretchable (and/or deformable permanently) in tranverse and longitudinal directions. For example, the material of the half-shells 101, 102 may comprise a formable paper material, preferably having a grammage between 50 g/m² to 150 g/m². For example, the formable paper material may be a Kraft paper. Preferably, the formable paper material may be exclusively made of cellulose fibers. Therein, elongation at break may generally be understood as the ratio between changed length and initial length before breakage of the test specimen, and can be used as a measure to quantify the resistance of a material to changes of the shape without breaking or crack formation. For example, the elongation at break can be determined by tensile testing following EN ISO 527. The work up to break of the material of the half-shells 101, 102 may be between 100 Nmm and 200 Nmm. By selectively choosing the paper-based material of the primary layer 171, is possible to provide the pod 100, 200 with sufficient rigidity, stiffness and/or form-stability to build up pressure inside the pod 100 during the preparation of a beverage. Conventional paper-based material may also be selected depending on the process selected for forming the half-shells.

The multi-layered body structure 170 may further comprise a secondary layer 172 comprising at least an oxygen barrier function.

Preferably, the primary layer 171 is arranged opposite to the chamber 103 with respect to the secondary body layer 172 so that it forms the outer surface of the pod. This is exemplarily shown in FIGS. 1 and 2.

The secondary layer 172 may comprise a coating layer or preferably a multilayer compostable plastic film structure comprising one or more layer of Polylactic acid (PLA), Polybutylene succinate (PBS), Polybutylene adipate terephthalate (PBAT), Polyhydroxy alkanoate (PHA), Polycaprolactone (PCL), or any combination thereof.

The primary layer 171 and secondary layer 172 are preferably laminated together.

The multilayer compostable plastic film structure of the secondary layer 172 may further comprises at least one layer that is enriched with Calcium Carbonate (CaCO3) in a range between 1 and 70 weight %.

The oxygen barrier function is provided thanks to one or more additional layer comprising one or more of BVOH, PVOH, PGA (Polyglycolic acid), metal, SiOx or AlOx, or combination thereof, for instance. However, it is also conceivable that the secondary layer 172 may comprise other materials that are compatible with the pod's 100, 200 home-compostability. For example, the oxygen barrier provided by the secondary layer 172 may be lower than 5 cc/m²-day, preferably lower than 1 cc/m²-day, more preferred lower than 0.5 cc/m²-day.

Additionally, the secondary layer 172 may also have a moisture barrier function.

Preferably, the coating or the multilayer compostable plastic film structure may be applied (directly) onto the primary layer 171, to ensure a low permeability to gasses, good resistance to grease and water to the layered body structure 170 which may additionally become printable.

Preferably, the coating or the multilayer compostable plastic film structure may be applied (directly) onto the primary layer 171, to form a laminated duplex structure DS. The duplex structure DS is visible on FIG. 4.

The various layers of the multilayer plastic film structure of the secondary layer 172 may be connected to each other by heat sealing, ultrasonic sealing, and/or by use of an adhesive being applied between layers. In experiments, it was found that good results may be achieved with a preferably water-based dispersion of a polyester-polyurethane elastomer. Thereby, it was found that this composition of the adhesive allows to make the pod 100; 200 home-compostable because the adhesive itself is compostable.

As presented in FIGS. 1, 2 and 3, the primary layer 171 of one or both half-shells 101; 102 comprises at least one pre-cut hole 106 (scoring, cut or scratch) at the location of the delivery portion 130. The pre-cut holes 106 scorings or scratches extend solely on the primary layer 171 and are non-crossing. More specifically, the pre-cut holes 106 extend transversally over the primary layer thickness, preferably over 50% of the primary layer thickness without extending to the secondary layer 172. Hence the oxygen barrier function of the secondary layer 172 is fully kept.

The number of pre-cut holes 106 may vary, for example between 1 and 150 pre-cut holes depending on the required type of extraction.

The pre-cut holes 106 may also have different geometry and could for example be in the form of a circle, a slit, a cross or any other suitable shape. Here the pre-cut holes 106 as presented in FIG. 4 have a circular shape.

The pre-cut holes 106 are arranged to form a pre-cut hole's pattern 108. Different pre-cut hole's patterns may be used according to the size of the pod and/or according to the characteristics of the primary layer and/or of the opening means of the beverage production machine.

Different possible pre-cut hole's patterns are presented in FIGS. 5a to 5d. In FIG. 5a, the pre-cut holes 106 have circular openings and are arranged along one single circle. In FIG. 5b, the pre-cut holes 106 have circular openings and are arranged along nine concentric circles. In FIG. 5c, the pre-cut holes 106 have cross openings and are arranged with a mixing of two designs in a circle. In FIG. 5d, the pre-cut holes 106 have circular openings and are arranged along five concentric circles. The pre-cut holes are forming starter(s) during interaction of the pod with the external opening elements of the beverage production machine.

Depending on the pre-cut hole's pattern 108 and as presented in FIG. 3 where the pre-cut hole's pattern has pre-cut holes located on a single circle, the primary layer 171 of the pod 100, 200 may further comprises scratches provided at the surface of the primary layer. The scratches, cuts or scorings may be in the form of a geometric element like a circle or a square, a logo, an information I and/or a coded elements CE stamped on the external surface of said primary layer at the location of the delivery portion 130 and/or at the location of the injection portion 120. The geometric element, the logo, the stamped information I and/or the coded elements CE provides localized weakness of the primary layer 171 helping the opening interaction with the external opening elements of the beverage production machine during extraction of the pod 100, 200. The scratches as well as the pre-cut holes may form a specific scratch's pattern that may be used as a coding information for the capsule.

The pre-cut holes or scratches may be made on the primary layer 171 using different technologies. For example, mechanical puncturing or laser engraving. In a proposed solution, the pre-cut holes and/or scratches are made on the primary layer 171 prior to the application of the secondary layer 172 (that is applied for example by lamination) forming the oxygen and/or water (or moisture) barrier.

In addition, and as presented in FIGS. 1 and 2, the multi-layered body structure 170 further comprises a tertiary layer 173 having a filter function.

The tertiary layer 173 is compostable and comprises a filter material comprising one or more of Polylactic acid (PLA), Polybutylene succinate (PBS), Bio Polybutylene succinate (Bio PBS), Ecovio®, Cellulose fibers-based material, Regenerated cellulose (cellophane), or a combination thereof. The material may be selected according to the filtering needs depending on the substance to be extracted (R&G coffee, tea . . . ). The filter ensure that particles of the beverage ingredient does not end in the prepared beverage or do not clog the perforations done in the pod wall portion during extraction of the pod in the beverage production machine.

The specific structure of the tertiary layer 173 may be chosen accordingly. It has a structure comprised within the group comprising a non-woven structure, a calendared structure and a pierced structure.

As presented in FIGS. 1 and 4, the dimension of the tertiary layer 173 may be limited to a portion of the half-shell and as proposed may be limited to the delivery portion 130. The proposed dimension limitation has no impact on the extraction as the interaction of the pod with the beverage production machine specifically occurs at the location of the injection portion 120 and/or of the delivery portion 130. In the presented solution, the dimension of the filter element may be between 25 and 40 mm, for example around 32 mm.

A tertiary layer 173 with a similar filter element may also be proposed on the half-shell comprising the injection portion 120 as visible in FIG. 1.

In the embodiment of FIGS. 1 and 4, the tertiary layer 173 which is in the form of a disc is positioned on the secondary layer 172. The tertiary layer 173 comprising the filter element can be positioned loosely on the secondary layer and will be maintained in position thanks to the beverage ingredient that will be positioned inside the half-shelf. The tertiary layer 173 comprising the filter element can also be at least partially linked to the secondary layer 172. Any suitable means can be used. For example, the tertiary layer 173 can be sealed, glued, laminated embossed, lasered connected, etc to the secondary layer 172.

As presented in FIG. 2, the tertiary layer 173 can also extend on the whole surface of the half pod and be part of a laminated triplex comprising at least the primary layer 171, the secondary layer 172 and the tertiary layer. The laminated triplex, then forms the multi-layered body structure 170 referenced in FIG. 2.

As presented in FIG. 1, the pod 100 may further comprise a sealing layer or a sealing lacquer 174 applied on the secondary layer 172 at the location of the half-shell's flange 140 for allowing or improving the sealing of the two half-shells together.

With reference to FIG. 2, in the case a multi-layered body structure 170 formed with a laminated triplex and depending on the material and material structure selected for the tertiary layer 173 an additional sealing layer/lacquer to be applied at the location of the half-shell's flange 140 may be needed.

As proposed, a method for manufacturing the described pods 100,200 for preparing a beverage in a beverage production machine will below be presented.

The method comprises the step of providing two first sheet elements comprising the described multi-layered body structure 170 (comprising the tertiary layer or not).

The two first sheet elements are formed into the shape of a half-shell (such as the aforementioned half-shells 101, 102, respectively. For example, the first sheet elements or the two multi-layered body structures 170 may be formed into the shape of a half-shell 101, 102, respectively, by drawing at least part of the respective multi-layered body structure 170 into a forming die. For this, preferably a mechanical punch may be used for deep drawing the respective multi-layered body structure 170. However, this is only an example and other processes are conceivable.

If the tertiary layer 173 is not part of the multi-layered body structure 170, it may be applied prior to filling one of the half-shells with the beverage ingredient substance. Once one of the half-shells is filled, the two half-shells are connected and sealed together to form the final pod.

The pre-cut hole's pattern as well as the scratches provided for example in the form of stamped information and/or coded element may be applied before the application of the barrier layer on the primary paper layer, before the shaping of the half-shell or when the pod is finished.

The pod is then ready to be used.

The invention is not limited by the embodiments as described hereinabove, as long as being covered by the appended claims. All the features of the embodiments described hereinabove can be combined in any possible way and be provided interchangeably.

Although the invention has been described by way of example, it should be appreciated that variations and modifications may be made without departing from the scope of the invention as defined in the claims. Furthermore, where known equivalents exist to specific features, such equivalents are incorporated as if specifically referred in this specification.

1. A pod for preparing a beverage in a beverage production machine, wherein the pod is made of a biodegradable material composition and comprises a pod body composed of two half-shells being connected to each other along their respective circumferential flange so as to define a chamber for containing a substance for the preparation of the beverage, wherein at least one half-shell comprises in a layered manner:
A primary layer made of a paper-based material,
A secondary layer with at least an oxygen barrier function, and
An at least partial tertiary layer with a filter function,
wherein the primary layer of said at least one half-shell comprises at least one non-traversing, pre-cut hole and/or scratch, forming a pre-cut hole's pattern or scratch's pattern, over at least a delivery portion of the half-shell adapted to interact with external opening elements of the beverage production machine, under the effect of rising pressure of the fluid being injected into the pod through an injection portion on the other half-shell, to dispense the prepared beverage from the pod-.

2. The pod according to claim 1, wherein the primary layer is made of stretchable and/or formable paper-based material having an elongation at break of at least 6%.

3. The pod according to claim 1, wherein the primary layer is arranged opposite to the chamber with respect to the secondary layer.

4. The pod according to claim 1, wherein the tertiary layer is arranged facing the chamber with respect to the secondary layer.

5. The pod according to claim 1, wherein the pre-cut hole(s) and/or scratch(es) are non-traversing and extend over the primary layer thickness.

6. The pod according to claim 1, wherein the primary layer is made of a biodegradable paper-based material selected from the group consisting of paper, supercalendered paper, filter paper and combination thereof and has a grammage comprised between 50 and 150 g/m².

7. The pod according to claim 1, wherein the primary layer comprises between 1 and 150 holes.

8. The pod according to claim 1, wherein the primary layer and/or the scratch pattern comprises decoration, logo, information and/or coded elements stamped on the external surface of said primary layer at the location of the delivery portion and/or at the location of the injection portion, providing localized weakness of the primary layer.

9. The pod according to claim 1, wherein the secondary layer is biodegradable, preferably compostable and comprises a coating or a preferably multilayer, compostable plastic film structure.

10. The pod according to claim 1, wherein at least a layer, preferably the outer and/or the inner layer of the preferably multilayer compostable plastic film structure is enriched with Calcium Carbonate (CaCO3) in a range between 1 and 70 weight %.

11. The pod according to claim 1, wherein the secondary layer comprises at least one layer having an oxygen and/or water barrier function, said layer comprising a layer/coating selected from the group consisting of:
a Butenediol-vinyl-alcohol-copolymer (BVOH) layer,
a Polyvinyl alcohol (PVOH) layer,
a PVOH copolymer layer,
a Polyglycolic acid (PGA) layer,
a metallization coating,
a SiOx based coating,
an AlOx based coating and
a combination thereof.

12. The pod according to claim 1, wherein the coating forming the secondary layer is applied onto the primary layer after the forming of the at least one non-traversing pre-cut hole and/or scratch.

13. The pod according to claim 1, wherein the tertiary layer is biodegradable.

14. The pod according to claim 1, wherein the tertiary layer has a structure selected from the group consisting of a non-woven structure, a calendared structure and a pierced structure.

15. The pod according to claim 1, wherein the tertiary layer extends at least over the delivery portion of the half-shell.

16. The pod according to claim 1, wherein the at least partial tertiary layer is positioned on the secondary layer loosely or is at least partially linked to the secondary layer.

17. The pod according to claim 1, wherein the tertiary layer is part of a laminated triplex structure comprising at least the primary layer, the secondary layer and the at least partial tertiary layer.

18. The pod according to claim 1, wherein the secondary layer or the tertiary layer further comprises a sealing layer or a sealing lacquer at least at the location of the half-shell's flange for allowing the sealing of the two half-shells together.

19. (canceled)
